(19) United States
(12) Patent Application Publication
(10) Pub. No.: US 2023/0306824 A1
(43) Pub. Date: Sep. 28, 2023

(54) AUTHORIZED RESOURCE DISTRIBUTION VIA A RESOURCE DISTRIBUTION NODE IN A DISTRIBUTED NETWORK OF NODES

(71) Applicant: BANK OF AMERICA CORPORATION, Charlotte, NC (US)

(72) Inventors: Paul Martin Mattison, Sherrills Ford, NC (US); Martha Sain McClellan, Lancaster, SC (US); Yash Sharma, Delhi (IN); David Smiddy, Chadds Ford, PA (US)

(73) Assignee: BANK OF AMERICA CORPORATION, Charlotte, NC (US)

(21) Appl. No.: 17/706,282

(22) Filed: Mar. 28, 2022

(51) Int. Cl. G07F 19/00; H04L 9/32

(52) U.S. Cl. CPC G07F 19/211; G07F 19/206; G07F 19/203; H04L 9/321; H04L 9/3247; H04L 2209/38; H04L 2209/56

(57) ABSTRACT

A network of nodes for a distributed register, in which the nodes include interaction terminals (e.g., ATMs, recyclers, point-of-sale devices, or the like). The interaction terminals allow a user to enter into an interaction that includes transferring resources through the use of the distributed register. The interaction terminals may be utilized in order to authenticate the user using traditional authentication processes or through the use of the distributed register. The interaction terminals may determine if the interaction is for a traditional interaction or if the interaction is being used for an interaction on the distributed ledger. Since the interaction terminals are operated by the organizations, they can be registered as trusted authorities on the distributed register, and as such, the blocks created for interactions by the interactional terminals may be validated without the need for consensus algorithms, or with reduced consensus requirements.

### FIELD OF THE INVENTION

The present disclosure relates to utilizing interaction terminals as trusted authorities as validators for a blockchain network, and in particular utilizing automated teller machines (ATMs) as trusted authorities.

### BACKGROUND

Interaction terminals do not have the ability to interact with certain networks, including blockchain networks. Moreover, the use of blockchain networks may be time consuming and inefficient when providing consensus for verification.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments if the invention comprises systems, computer program products, or computer implemented methods for a network of nodes for a distributed register, in which the nodes include interaction terminals (e.g., ATMs, recyclers, point-of-sale devices, or the like). The interaction terminals allow a user to enter into an interaction that includes transferring resources through the use of the distributed register. The interaction terminals may be utilized in order to authenticate the user using traditional authentication processes or through the use of the distributed register. The interaction terminals may determine if the interaction is for a traditional interaction (e.g., using traditional functions of ATMs, recyclers, point-of-sale devices, or the like) or if the interaction is being used for an interaction on the distributed ledger. Since the interaction terminals are operated by the organizations, they can be registered as trusted authorities on the distributed register, and as such, the blocks created for interactions by the interactional terminals may be validated without the need for consensus algorithms, or with reduced consensus requirements. It should be understood that the interactions may be any type of interaction, such as but not limited to the exchange of resources between two entities, the exchange of resources for a product, accessing resource pools of the user, or the like. In particular embodiments, resources may be transferred electronically to a user computer system of the user. In alternate embodiments, resources may be dispensed by the interaction terminal for the interaction (e.g., ATM dispenses paper, a card, or the like for the value of the resources).

One embodiment of the invention comprises a system for validating an interaction using a distributed network of nodes. The system comprises one or more memory devices with computer-readable program code stored thereon, one or more communication devices, and one or more processing devices operatively coupled to the one or more memory devices and the one or more communication devices. The one or more processing devices are configured to execute the computer-readable program code to receive a request from a user to enter into an interaction using a node, wherein the node is an interaction terminal. The one or more processing devices are further configured to execute the computer-readable program code to receive interaction information for the interaction, authenticate the user making the request for the interaction, identify that the interaction is for a blockchain interaction, and generate a new block for the blockchain interaction. The one or more processing devices are further configured to receive an indication that the new block is validated, wherein the new block is validated based on the interaction terminal used to create the new block, and complete the interaction by electronically transferring resources to a user computer system of the user or dispensing physical resources to the user.

In further accord with embodiments, authenticating the user making the request is performed using traditional authentication processes for interaction terminals.

In other embodiments, authenticating the user making the request is performed by a consensus of interaction terminals on the blockchain.

In yet other embodiments, the new block is generated by the interaction terminal using an interaction terminal identifier that is registered as a trusted authority.

In still other embodiments, the new block is validated by one or more other nodes after confirming that the interaction terminal identifier is identified as the trusted authority.

In other embodiments, the new block is validated by one or more other nodes by determining that the new block was generated by the interaction terminal, determining that there are no other blocks generated by the interaction terminal at a same interval, and determining that the new block is signed correctly.

In further accord with embodiments, the request to enter into the interaction is received from a user computer system of the user before the user accesses the interaction terminal.

In other embodiments, the new block is generated only after the user confirms the interaction through the interaction terminal.

In yet other embodiments, the new block is generated and the interaction is completed by the user through the user computer system without the user accessing the interaction terminal.

In still other embodiments, the request to enter into the interaction is received from the user at the interaction terminal.

In other embodiments, the interaction terminal is an automated teller machine (ATM) or recycler.

In further accord with embodiments, the computer-readable program code stored on the one or more memory devices comprises semi-conductor computer-readable code, interaction processing and encryption computer-readable code, resource withdraw and deposit computer-readable code, and blockchain computer-readable code for allowing the interaction terminal to communicate with the blockchain.

In other embodiments, the interaction terminal is a point of sale terminal.

In yet other embodiments the interaction is completed by electronically transferring resources to the user computer system, and wherein a resource amount for the resources is stored in a digital wallet of the user on the user computer system.

In still other embodiments, the interaction is completed by dispensing a resource instrument to the user, and wherein the resource instrument stores a resource amount for the resources through the resource instrument.

In other embodiments, the interaction is completed by exchanging a distributed register resource value for the distributed register into a local resource value for a location of the user.

In yet other embodiments, the interaction is completed by exchanging a second resource value from a second entity to a distributed register resource value for a distributed register, and exchanging the distributed register resource value into a local resource value for a location of the user.

Another embodiment of the invention comprises a computer program product for validating an interaction using a distributed network of notes. The computer program product comprising at least one non-transitory computer readable medium having computer-readable program code portions embodied therein. The computer-readable program code portions comprise executable portions for receiving a request from a user to enter into an interaction using a node, wherein the node is an interaction terminal. The computer-readable program code portions further comprise executable portions for receiving interaction information for the interaction, authenticating the user making the request for the interaction, identifying that the interaction is for a blockchain interaction, and generating a new block for the blockchain interaction. The computer-readable program code portions further comprise receiving an indication that the new block is validated, wherein the new block is validated based on the interaction terminal used to create the new block, and completing the interaction by electronically transferring resources to a user computer system of the user or dispensing physical resources to the user.

In further accord with embodiments, the interaction is completed by electronically transferring resources to the user computer system, wherein a resource amount for the resources is stored in a digital wallet of the user on the user computer system, or by dispensing a resource instrument to the user, wherein the resource instrument stores the resource amount for the resources through the physical instrument.

Another embodiment of the invention comprises a computer-implemented method for validating an interaction using a distributed network of nodes by one or more processing devices. The computer-implemented method comprises receiving, by one or more processors, a request from a user to enter into an interaction using a node, wherein the node is an interaction terminal The computer-implemented method further comprises receiving interaction information for the interaction, authenticating the user making the request for the interaction, identifying that the interaction is for a blockchain interaction, and generating a new block for the blockchain interaction. The computer-implemented method further comprises receiving an indication that the new block is validated, wherein the new block is validated based on the interaction terminal used to create the new block, and completing the interaction by electronically transferring resources to a user computer system of the user or dispensing physical resources to the user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates an operating environment for a distributed network of nodes, in accordance with one embodiment of the present disclosure;

FIG. 2 is a block diagram illustrating the data structures within an exemplary distributed register, in accordance with one embodiment of the present disclosure; and

FIG. 3 is a flow diagram illustrating a process for utilizing interaction terminals as nodes to provide trusted validation within the distributed register, in accordance with one embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Entity” as used herein may refer to an individual or an organization that owns and/or operates an online system of networked computing devices, systems, and/or peripheral devices on which the system described herein is implemented. The entity may be a business organization such as a financial institution, a non-profit organization, a government organization, and the like, which may routinely use various types of applications within its enterprise environment to accomplish its organizational objectives.

“The system” or “entity system” as used herein may refer to the computing systems, devices, software, applications, communications hardware, and/or other resources used by the entity to perform the functions as described herein. Accordingly, the entity system may comprise desktop computers, laptop computers, servers, Internet-of-Things (“IoT”) devices, networked terminals, mobile smartphones, smart devices (e.g., smart watches), network connections, and/or other types of computing systems or devices and/or peripherals along with their associated applications.

“Computing system” or “computing device” as used herein may refer to a networked computing device within the entity system. The computing system may include a processor, a non-transitory storage medium, a communications device, and a display. The computing system may be configured to support user logins and inputs from any combination of similar or disparate devices. Accordingly, the computing system may be a portable electronic device (otherwise described as a mobile computing system), such as a smartphone, tablet, single board computer, smart device, laptop, wearable device, or the like. In other embodiments, the computing system may be a stationary unit such as a personal desktop computer, networked terminal, IoT device, or the like.

“User” as used herein may refer to an individual who may interact with the entity system to access the functions therein. Accordingly, the user may be an agent, employee, associate, contractor, or other authorized party who may access, use, administrate, maintain, and/or manage the computing systems within the entity system. In other embodiments, the user may be a client or customer of the entity.

Accordingly, as used herein, the term “user device”, “user computer system”, “mobile device”, or “mobile computer system”, may refer to mobile phones, personal computing devices, tablet computers, wearable devices, and/or any portable electronic device capable of receiving and/or storing data therein.

“Distributed register,” which may also be referred to as a “distributed ledger,” as used herein may refer to a structured list of data records that is decentralized and distributed amongst a plurality of computing systems and/or devices. In some embodiments, the distributed ledger may use a linked block structure.

“Linked block,” “linked block structure,” or “blockchain” as used herein may refer to a data structure which may comprise a series of sequentially linked “blocks,” where each block may comprise data and metadata. The “data” within each block may comprise one or more “data record” or “transactions,” while the “metadata” within each block may comprise information about the block, which may include a timestamp, a hash value of data records within the block, and a pointer (e.g., a hash value) to the previous block in the linked block structure. In this way, beginning from an originating block (e.g., a “genesis block”), each block in the linked block structure is linked to another block via the pointers within the block headers. If the data or metadata within a particular block in the linked block structure becomes corrupted or modified, the hash values found in the header of the affected block and/or the downstream blocks may become mismatched, thus allowing the system to detect that the data has been corrupted or modified.

A “lined block register,” which may also be referred to as a “linked block ledger”, may refer to a distributed register which uses linked block data structures. Generally, a linked block register is an “append only” register in which the data within each block within the linked block register may not be modified after the block is added to the linked block register; data may only be added in a new block to the end of the linked block register. In this way, the linked block register may provide a practically immutable register of data records over time.

“Permissioned distributed register”, which may also be referred to as a “permission distributed ledger”, as used herein may refer to a linked block register for which an access control mechanism is implemented such that only known, authorized users may take certain actions with respect to the linked block register (e.g., add new data records, participate in the consensus mechanism, or the like). Accordingly, “unpermissioned distributed register” as used herein may refer to a linked block register without an access control mechanism.

“Private distributed register”, which may also be referred to as a “private distributed leger”, as used herein may refer to a linked block register accessible only to users or devices that meet specific criteria (e.g., authorized users or devices of a certain entity or other organization). Accordingly, a “public distributed register”, which may also be referred to as a “private distributed register”, is a linked block register accessible by any member or device in the public realm.

“Node” as used herein may refer to a computing system on which the distributed register is hosted. In some embodiments, each node maintains a full copy of the distributed register. In this way, even if one or more nodes become unavailable or offline, a full copy of the distributed register may still be accessed via the remaining nodes in the distributed register system. That said, in some embodiments, the nodes may host a hybrid distributed register such that certain nodes may store certain segments of the linked block register but not others.

“Consensus,” as used herein may refer to the process or processes by which nodes come to an agreement with respect to the contents of the distributed register. Changes to the register (e.g., addition of data records) may require consensus to be reached by the nodes in order to become a part of the authentic version of the register. In this way, the consensus mechanism may ensure that each node, or a subset of the nodes, maintains a copy of the distributed register, or portions thereof, that is consistent with the copies of the distributed register, or portions thereof, hosted on the other nodes; if the copy of the distributed register, or portions thereof, hosted on one node becomes corrupted or compromised, the remaining nodes may use the consensus algorithm to determine the “true” version of the distributed register.

The “consensus” may a “consensus algorithm” otherwise described as a “consensus mechanism”, such as proof-of-work (“PoW”), proof-of-stake (“PoS”), practical byzantine fault tolerance (“PBFT”), proof-of-authority (“PoA”), or the like. In some embodiments, the consensus requirement may be enhanced and/or replaced by one or more of a plurality interaction terminals that operate as nodes for the distributed register and/or can communicate with the distributed register. The interaction terminals may be automated teller machines (“ATMs”), cash recyclers, point-of-sale devices (“POS devices”), kiosks, or other like terminals within a single entity or owed by different entities. The one or more interaction terminals may be used to authenticate a user entering into an interaction, as well as may act as a trusted authority for validation of interactions (e.g., a piece of information within an interaction, the interaction itself, or the like). As such, the interaction may be validated on the distributed register without requiring PoW, PoS, and/or PoA consensus. The validation provided by the one or more interaction terminals relies on the trustworthiness of the entities operating the interaction terminals. As will be described herein, the interaction terminals may be registered (e.g., through interaction terminal identifiers) and can confirm interactions to improve the speed of interactions (e.g., does not require traditional consensus algorithms that take time), improves efficiency (e.g., the energy consumptions required by mining or other traditional consensus process is reduced), improves accuracy (e.g., terminals have built in authentication), or the like. In some embodiments the interaction terminals may be a node for the distributed register and/or communicate with nodes for the distributed register that perform traditional consensus.

“Smart contract” as used herein may refer to executable computer code or logic that may be executed according to an agreement between parties upon the occurrence of a condition precedent (e.g., a triggering event such as the receipt of a proposed data record). In some embodiments, the smart contract may be self-executing code that is stored in the distributed register, where the self-executing code may be executed when the condition precedent is detected by the system on which the smart contract is stored. The smart contracts may be utilized to allow for the interactions, the authorization of the interactions, and the validation on the distributed register to occur through the use of the interaction terminal and captured on the blockchain.

“Resource” as used herein may refer to tangible or intangible objects which may be held, owned, or used by a user and/or the entity. In this regard, examples of such resources may include electronic data files, documents, computing devices and/or other types of electronic hardware, physical objects, funds, financial instruments, computing resources, or the like. In some embodiments, a resource may be associated with one or more accounts (e.g., a user account). Accordingly, “resource transfer” or “resource transfer process” as used herein may refer to a transfer of resources from a resource origin to a resource destination, such as a data transfer, provisioning of hardware, transaction (e.g., funds transfer), or the like.

“Non-fungible token” or “NFT” as used herein may refer to data stored in a distributed register that may comprise a signature (e.g., a hash value or address) associated with a digital resource, where the signature certifies that the digital resource is unique (e.g., not interchangeable with other resources). The signature may further identify the owner of the digital resource (e.g., a user, entity, or the like). In this regard, the ownership of the digital resource may be governed by a smart contract stored within the distributed register and associated with the digital resource and/or the NFT. Examples of such digital resources may include image files, audio files, video files, documents, web pages, and the like. In particular, the digital resource may include a secure token that may serve as a data identifier associated with a particular computing device (e.g., a mobile device). In other embodiments, the signature may identify the owner of a non-digital resource, which may include physical objects (e.g., a tradeable card) and/or non-physical objects (e.g., securities) that may be associated with the signature. In some embodiments, the digital resource may be stored separately from the distributed register (e.g., off-chain on a database server). In other embodiments, the digital resource may be stored within the distributed register (e.g., on-chain within block data).

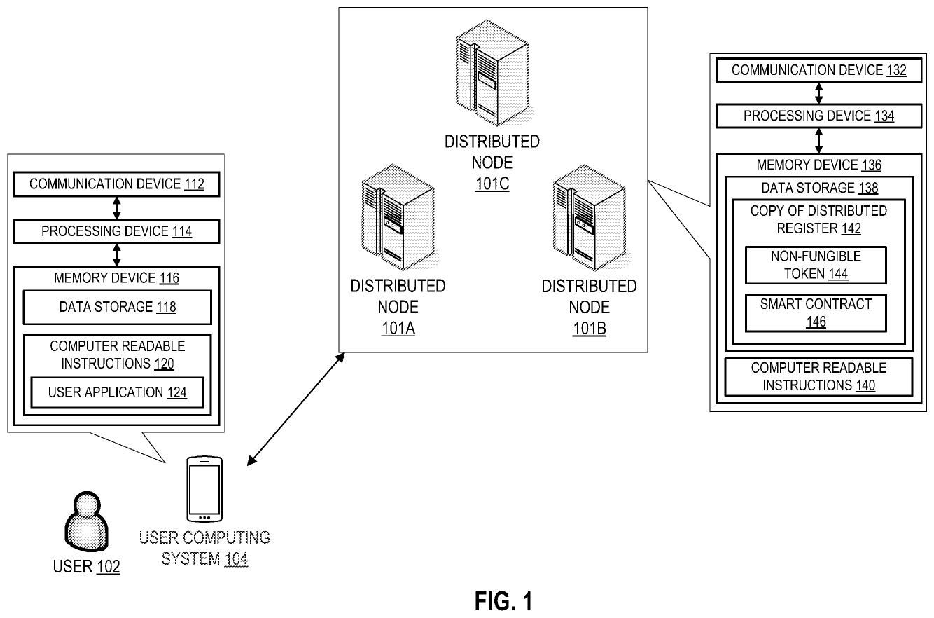

Turning now to the figures, FIG. 1 illustrates an operating environment 100 for the node network system (e.g., interaction terminal node network, or the like), in accordance with one embodiment of the present disclosure. In particular, FIG. 1 illustrates a user computing device 104 in operative communication with a plurality of distributed server nodes 101A, 101B, 101C over a network. In such a configuration, the computing systems within the network, including the user computing device 104 and distributed server nodes 101A, 101B, 101C may transmit data to and/or receive data from one another through the network. It should be understood that the nodes 101A, 101B, 101C, or 101nth may be interaction terminals, as previously described herein, such as ATMs, recyclers, entity POS devices, or the like.

It should be understood that FIG. 1 illustrates only an exemplary embodiment of the operating environment 100 for the node network system, and it will be appreciated that the operating environment 100 may comprise fewer or greater numbers of computing systems than what is depicted in FIG. 1. For example, though FIG. 1 depicts three distributed node systes 101A, 101B, 101C, the operating environment may comprise a greater (e.g., an nth number of nodes) or fewer number of distributed node systems depending on the embodiment. Moreover, other computer systems, such as other servers, systems, or the like, may or may not be considered nodes 101, and in some embodiments may be included in and/or communicate with the operating environment 100 for the node network system. For example, entity systems that may be operate, support, service, or the like the nodes 101 may communicate over the system. Alternatively, or additionally, third-party entity systems that provide products (e.g., goods or services) may be included in and/or communicate with the operating environment 100 for the distributed node network system. It should also be appreciated that one or more functions of the systems, devices, or servers as depicted in FIG. 1 may be combined into a single system, device, or server and/or be performed by other computing systems. Furthermore, the functions of a single system, device, or server as depicted in FIG. 1 may be distributed across multiple computing systems.

The network may be a system specific distributive network, which receives and distributes specific network feeds and identifying specific network associated triggers. The network may include one or more cellular radio towers, antennae, cell sites, base stations, telephone networks, cloud networks, radio access networks (RAN), Wi-Fi networks, or the like. Additionally, the network may also include a global area network (GAN), such as the Internet, a wide area network (WAN), a local area network (LAN), or any other type of network or combination of networks. Accordingly, the network may provide for wireline, wireless, or a combination wireline and wireless communication between devices on the network.

As illustrated in FIG. 1, the distributed nodes 101A, 101B, 101C may form a cluster of nodes that host a distributed register. Accordingly, the distributed server nodes 101A, 101B, 101C may each comprise one or more communication devices 132, one or more processing devices 134, and one or more memory devices 136, where the one or more processing devices 134 are operatively coupled to the one or more communication devices 132 and the one or more memory devices 136. The one or more processing devices 134 use the one or more communication devices 132 to communicate with the network and other devices on the network. As such, the one or more communication devices 132 may generally comprises a modem, antennae, electrical connection, Wi-Fi or Ethernet adapter, radio transceiver, or other device for communicating with other devices on the network. The one or more communication devices 132 may further comprise an interface that accepts one or more network interface cards, ports for connection of network components, Universal Serial Bus (USB) connectors, or the like. Moreover, the one or more communication devices 132 may include input and/or output devices, such as a keypad, keyboard, touch-screen, touchpad, microphone, mouse, joystick, other pointer component, button, soft key, and/or other input/output component(s) for communicating with the users 4. As such, the nodes may include a display that allows for the input and output of information over a graphical user interface.

The one or more memory devices 136 comprise computer-readable instructions 140 and data storage 138, where the data storage 138 may comprise a copy of a distributed register 142 (e.g., entire register, a portion thereof, or the like). The distributed register (and the copy of the distributed register 142), as described elsewhere herein, may comprise a series of data records relevant to the objectives of an entity associated with the distributed server network. In this regard, the distributed server nodes 101A, 101B, 101C may be able to read data from the distributed register, submit data records to the distributed register, participate in consensus mechanisms, or the like. The copy of the distributed register 142 may further comprise a smart contract 146 containing the information for an interaction between two entities (e.g., two individuals, two organizations, one individual and one organization, or the like).

Moreover, in the embodiments in which the note is an interaction terminal, the computer readable instructions 140 may further include the instructions for operating the interaction terminal, such as computer readable instructions for the operation of the ATMs, cash recyclers, entity POS terminals, or the like. As such, in some embodiments the computer readable instructions 140 may include computer-readable code for operation of the semi-conductor, for interaction processing and encryption, for resource withdraw and deposit, for the distributed register, for allowing communication with a distributed register, or other like code.

As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The network may comprise a wireless local area network (WLAN) such as Wi-Fi based on the Institute of Electrical and Electronics Engineers' (IEEE) 802.11 standards, Bluetooth short-wavelength UHF radio waves in the ISM band from 2.4 to 2.485 GHz or other wireless access technology. Alternatively, or in addition to the wireless interface, the systems may include a communication interface device that may be connected by a hardwire connection to the resource distribution device. The interface device may comprise a connector such as a USB, SATA, PATA, SAS or other data connector for transmitting data to and from the respective computing system. As such, the network may provide for wireline, wireless, or a combination of wireline and wireless communication between systems, servers, and/or devices on the network.

As further illustrated in FIG. 1, the user computing system 104 (or user computer system 104) may be in operative communication with the distributed node systems 101A, 101B, 101C. The user computing system 104 may be a device that may be owned and/or operated by a user (e.g., the user 102). In particular, the user computing system 104 may be a portable device (otherwise described as a mobile device), such as a smartphone which may be used to access resource pool information of the user, aid in entering interactions through the user computing system 104, alone or in combination with a node, access the copy of the distributed register 142 stored on the distributed server nodes 101A, 101B, and 101C for the purpose of entering into interactions, including authorizing an interaction.

Accordingly, the user computing system 104 may comprise one or more communication devices 112, one or more processing devices 114, and one or more memory devices 116. In some embodiments, the user computing system 104 may comprise hardware and/or software components that allow the user computing device 104 to interface with the user 102.

The one or more memory devices 116 of the user computing system 104 may further comprise data storage 118 and computer-readable instructions 120 stored thereon, where the computer-readable instructions 120 may comprise one or more user applications 124. The one or more user applications 124 may be a software application that allows for the user 102 to enter into interactions, authenticate the user 102, communicate with the interactional terminals, access a distributed register, and/or perform one or more additional tasks that may or may not be specifically described herein. Accordingly, in some embodiments, the user application 124 may be an application provided by the entity and configured to access the distributed server nodes 101A, 101B, 101C. In other embodiments, the user application 124 may be a third party application such as a web browser, dedicated app, or the like, which may be used to access an entity server configured to provide selective access to the distributed server nodes 101A, 101B, 101C (e.g., which may or may not be operated by the third-party).

The one or more communication devices 112 may generally comprise a modem, antennae, electrical connection, Wi-Fi or Ethernet adapter, radio transceiver, or other device for communicating with other devices on the network. The one or more communication devices 112 may further comprise an interface that accepts one or more network interface cards, ports for connection of network components, Universal Serial Bus (USB) connectors, or the like. In such embodiments, the one or more communication devices 112 of the user computing device 104 may comprise a user interface comprising one or more input devices (e.g., a keyboard, keypad, microphone, speaker mouse, tracking device, joystick, button, soft key, biometric readers, capacitive sensors, touch-screen, touchpad, or the like) and/or output devices (e.g., a display such as a monitor, projector, headset, touchscreen, and/or auditory output devices such as speakers, headphones, or the like) for communicating with the users 4. As such, the user computer system 104 may include a display that allows for the input and output of information over a graphical user interface.

The computing systems described (e.g., the user computing systems 104, the nodes 100, and/or other entity systems) herein may each further include a power source, a clock or other timer, a camera, a positioning system device (e.g., GPS, WiFi triangulation, NFC, or the like), a gyroscopic device, one or more chips, and the like.

In some embodiments, the computing systems may access one or more databases or datastores (not shown) to search for and/or retrieve information related to the service provided by the entity. The computing systems may also access a memory and/or datastore local to the various systems within the operating environment 100.

The processing devices as described herein may include functionality to operate one or more software programs or applications, which may be stored in the memory device. For example, a processing device may be capable of operating a connectivity program, such as a web browser application, dedicated application, or the like. In this way, the systems may transmit and receive web content, such as, for example, product valuation, service agreements, location-based content, and/or other web page content, according to a Wireless Application Protocol (WAP), Hypertext Transfer Protocol (HTTP), and/or the like.

A processing device may also be capable of operating applications. The applications, or at least potion thereof, may be downloaded from a server and stored in the memory device of the computing systems. Alternatively, the applications, or at least portion thereof, may be pre-installed and stored in a memory in a chip (e.g., semi-conductor, or the like).

The chip may include the necessary circuitry to provide integration within the devices depicted herein. Generally, the chip will include data storage which may include data associated with the service that the computing systems may be communicably associated therewith. The chip and/or data storage may be an integrated circuit, a microprocessor, a system-on-a-chip, a microcontroller, or the like. In this way, the chip may include data storage. Of note, it will be apparent to those skilled in the art that the chip functionality may be incorporated within other elements in the devices. For instance, the functionality of the chip may be incorporated within the memory device and/or the processing device. In a particular embodiment, the functionality of the chip is incorporated in an element within the devices. Still further, the chip functionality may be included in a removable storage device such as an SD card or the like.

A processing device may be configured to use the network interface to communicate with one or more other devices on a network. In this regard, the network interface may include an antenna operatively coupled to a transmitter and a receiver (together a “transceiver”). The processing device may be configured to provide signals to and receive signals from the transmitter and receiver, respectively. The signals may include signaling information in accordance with the air interface standard of the applicable cellular system of the wireless telephone network that may be part of the network. In this regard, the computing systems may be configured to operate with one or more air interface standards, communication protocols, modulation types, and access types. By way of illustration, the devices may be configured to operate in accordance with any of a number of first, second, third, fourth, fifth, and/or sixth-generation communication protocols and/or the like. For example, the computing systems may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with fifth-generation (5G) wireless communication protocols, with sixth (6G) wireless communication protocols, or the like. The devices may also be configured to operate in accordance with non-cellular communication mechanisms, such as via a wireless local area network (WLAN) or other communication/data networks.

The network interface may also include an application interface in order to allow a user or service provider to execute some or all of the above-described processes. The application interface may have access to the hardware (e.g., the transceiver, and software previously described with respect to the network interface). Furthermore, the application interface may have the ability to connect to and communicate with an external data storage on a separate system within the network.

The devices may further include a power source. Generally, the power source is a device that supplies electrical energy to an electrical load. In some embodiments, a power source may convert a form of energy such as solar energy, chemical energy, mechanical energy, or the like to electrical energy. Generally, the power source may be a battery, such as a lithium battery, a nickel-metal hydride battery, or the like, that is used for powering various circuits (e.g., the transceiver circuit, and other devices that are used to operate the devices). Alternatively, the power source may be a power adapter that can connect a power supply from a power outlet to the devices. In such embodiments, a power adapter may be classified as a power source “in” the devices.

As described above, the computing devices as shown in FIG. 1 may also include a memory device operatively coupled to the processing device. As used herein, “memory” may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like.

The memory device may store any of a number of applications or programs which comprise computer-executable instructions/code executed by the processing device to implement the functions of the devices described herein.

Each computing system may also have a control system for controlling the physical operation of the device. The control system may comprise one or more sensors for detecting operating conditions of the various mechanical and electrical systems that comprise the computing systems or of the environment in which the computing systems are used. The sensors may communicate with the processing device to provide feedback to the operating systems of the device. The control system may also comprise metering devices for measuring performance characteristics of the computing systems. The control system may also comprise controllers such as programmable logic controllers (PLC), proportional integral derivative controllers (PID) or other machine controllers. The computing systems may also comprise various electrical, mechanical, hydraulic, or other systems that perform various functions of the computing systems. These systems may comprise, for example, electrical circuits, motors, compressors, or any system that enables functioning of the computing systems.

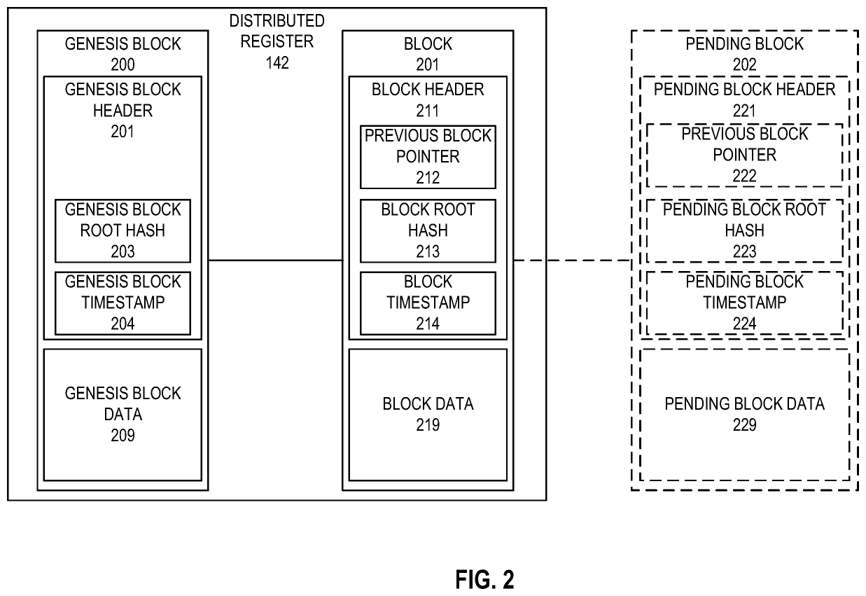

FIG. 2 is a block diagram illustrating the data structures within an exemplary distributed register, in accordance with some embodiments. In particular, FIG. 2 depicts a plurality of blocks 200, 201 within the distributed register 142, in addition to a pending block 202 that has been submitted to be appended to the distributed register 142. The distributed register 142 may comprise a genesis block 200 that serves as the first block and origin for subsequent blocks in the distributed register 142. The genesis block 200, like all other blocks within the distributed register 142, comprise a block header 201 and block data 209. The genesis block data 209, or any other instances of block data within the distributed register 142 (or any other distributed register) may contain one or more data records. For instance, block data may comprise software source code, authentication data, interaction data (e.g., transaction data), documents, or other data containers, third party information, regulatory and/or legal data, or the like.

The genesis block header 201 may comprise various types of metadata regarding the genesis block data 209. In some embodiments, the block header 201 may comprise a genesis block root hash 203, which is a hash derived from an algorithm using the genesis block data 209 as inputs. In some embodiments, the genesis block root hash 203 may be a Merkle root hash, wherein the genesis block root hash 203 is calculated via a hash algorithm based on a combination of the hashes of each data record within the genesis block data 209. In this way, any changes to the data within the genesis block data 209 will result in a change in the genesis block root hash 203. In some embodiments, the block header 201 may include an interaction terminal identifier of a trusted interaction terminal that created the block (e.g., the identifier, in hash, as part of the root has 203, or the like). The genesis block header 201 may further comprise a genesis block timestamp 204 that indicates the time at which the block was written to the distributed register 142. In some embodiments, the timestamp may be a Unix timestamp. In some embodiments, particularly in registers utilizing a PoW consensus mechanism, the block header 201 may comprise a nonce value and a difficulty value. The nonce value may be a whole number value that, when combined with the other items of metadata within the block header 201 into a hash algorithm, produces a hash output that satisfies the difficulty level of the cryptographic puzzle as defined by the difficulty value. For instance, the consensus mechanism may require that the resulting hash of the block header 201 falls below a certain value threshold (e.g., the hash value must start with a certain number of zeroes, as defined by the difficulty value).

A subsequent block 201 may be appended to the genesis block 200 to serve as the next block in the linked block structure. Like all other blocks, the subsequent block 201 comprises a block header 211 and block data 219. Similarly, the block header 211 comprise a block root hash 213 of the data within the block data 219, a block timestamp 214, the interaction terminal identifier, or the like. The block header 211 may further comprise a previous block pointer 212, which may be a hash calculated by combining the hashes of the metadata (e.g., the genesis block root hash 203, genesis block timestamp 204, and the like) within the block header 201 of the genesis block 200. In this way, the block pointer 212 may be used to identify the previous block (e.g., the genesis block 200) in the distributed register 142, thereby creating a “chain” comprising the genesis block 200 and the subsequent block 201.

The value of a previous block pointer is dependent on the hashes of the block headers of all of the previous blocks in the chain; if the block data within any of the blocks is altered, the block header for the altered block as well as all subsequent blocks will result in different hash values. In other words, the hash in the block header may not match the hash of the values within the block data, which may cause subsequent validation checks to fail. Even if an unauthorized user were to change the block header hash to reflect the altered block data, this would in turn change the hash values of the previous block pointers of the next block in the sequence. Therefore, an unauthorized user who wishes to alter a data record within a particular block must also alter the hashes of all of the subsequent blocks in the chain in order for the altered copy of the register to pass the validation checks imposed by the consensus. Thus, the computational impracticability of altering data records in a ledger in turn greatly reduces the probability of improper alteration of data records.

A pending block 202 or “proposed block” may be submitted for addition to the distributed register 142. The pending block 202 may comprise a pending block header 221, which may comprise a pending block root hash 223, a previous block pointer 222 that points to the previous block 201, a pending block timestamp 224, pending block data 229, and/or an interaction terminal identifier (e.g., alone, as part of the root hash, or the like). Once a pending block 202 is submitted to the system, the nodes within the system may validate the pending block 202 via a consensus algorithm. The consensus algorithm may be, for instance, a proof of work mechanism, in which a node determines a nonce value that, when combined with a hash of the block header 211 of the last block in the linked block structure, produces a hash value that falls under a specified threshold value. For instance, the PoW algorithm may require that said hash value begins with a certain number of zeroes. Once said nonce value is determined by one of the nodes, the node may post the “solution” to the other nodes. Once the solution is validated by the other nodes, the hash of the block header 211 is included in the pending block header 221 of the pending block 202 as the previous block pointer 222. The pending block header 221 may further comprise the pending block root hash 223 of the pending block data 229 which may be calculated based on the winning solution. The pending block 202 is subsequently considered to be appended to the previous block 201 and becomes a part of the distributed register 142. A pending block timestamp 224 may also be added to signify the time at which the pending block 202 is added to the distributed register 142.

In other embodiments, the consensus mechanism may be based on a total number of consensus inputs submitted by the nodes of the distributed register 142, e.g., a PBFT consensus mechanism. Once a threshold number of consensus inputs to validate the pending block 202 has been reached, the pending block 202 may be appended to the distributed register 142. In such embodiments, nonce values and difficulty values may be absent from the block headers. In still other embodiments, the consensus algorithm may be a Proof-of-Stake mechanism in which the stake (e.g., amount of digital currency, reputation value, or the like) may influence the degree to which the node may participate in consensus and select the next proposed block. In other embodiments, the consensus algorithm may be a Proof-of-Authority mechanism in which the identity of the validator itself (with an attached reputation value) may be used to validate proposed data records (e.g., the ability to participate in consensus/approval of proposed data records may be limited to approved and/or authorized validator nodes). In yet other embodiments, the consensus algorithm may comprise a manual node approval process rather than an automated process. Alternatively, or in addition to the consensus described above, as discussed herein, the validation of an interaction (e.g., the consensus mechanism) may be based on the interaction terminal identifier that indicates that the interaction terminal is a trusted authority. Similar to the Proof-of-Authority mechanism, the interaction terminal identifier may include or may have attached a reputation value. However, it should be understood that the interaction terminal identifier may not require a reputation value. It should be understood that the interaction terminal identifier itself may indicate that it is a trusted authority for creating blocks on the distributed register.

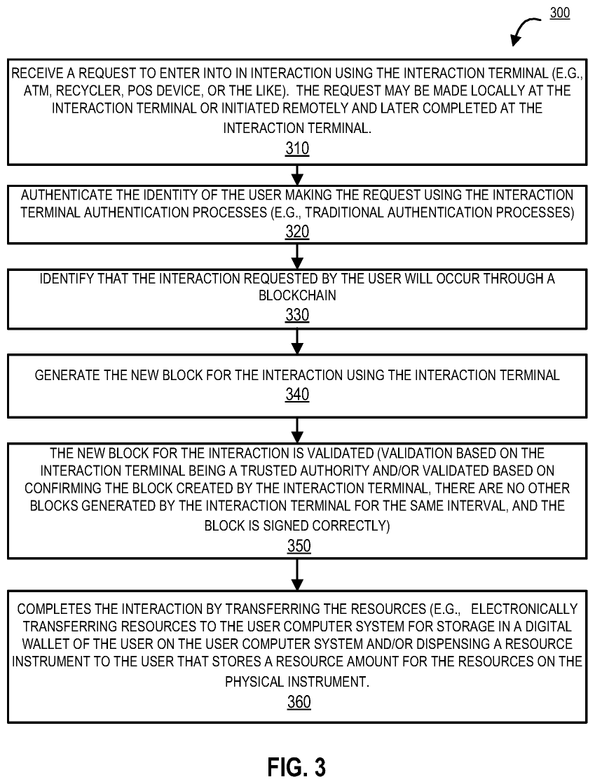

FIG. 3 is a flow diagram illustrating a process flow 300 for utilizing an interaction terminal (e.g., a trusted terminal, such as an ATM, recycler, POS device, or the like) as a node in a distributed network of nodes for providing validation of an interaction on the distributed register, in accordance with embodiments of the present disclosure

As illustrated in block 310 of FIG. 3, a request is received to enter into an interaction using the interaction terminal 101A. It should be understood that the request may be initiated locally at the interaction terminal, or it may be initiated remotely. In some embodiments, the user 102 may enter into an interaction using an interaction terminal that is a POS device, such as within a merchant store, at a kiosk, or the like. As such, the user 102 may be entering an interaction to exchange resources for a product (e.g., good or services). Alternatively, the user 102 may utilize an interaction terminal that is an ATM, resource recycler, terminal within a resource exchange center, or other terminal to enter into an interaction. For example, the user 102 may be accessing resources from a user resource pool, from a store of value on a distributed register, or the like. In other examples, the interaction may include transferring resources between entities (e.g., users, organizations, and/or a user and organization, or the like).

In other embodiments, the user 102 may initiate an interaction using the user computer system 104 when located remotely (e.g., at, near, or within a specified distance) from the one or more interaction terminals in order to enter and complete the interaction remote from the interaction terminals, or to initiate and later complete the interaction at an interaction terminal. The interaction requested may be made for any type of interaction.

As briefly described above, the interaction may be an interaction in which a user 102 provides resources for a product (e.g., good, service, or the like). For example, the user may receive a physical good or a service. In other examples, the interaction may include the user receiving resources, such as receiving physical resources from the interaction terminal (e.g., a resource instruments, such as a negotiable instrument, applied to a card, or the like). The resources received may be dispensed in local or non-local values (e.g., local values after being exchanged from non-local values of various countries or regions, exchanged from a non-fungible token value, exchanged from a cryptocurrency, stable coin, or the like value). Alternatively, the resources received may be received electronically, directly or indirectly, through the interaction terminal and stored within an electronic wallet of the user computer system 104 (e.g., pre-funded resources). In the embodiments when the resources are being received by the user 102, the resources may be received in exchange for resources being debited from a resource pool of the user 102, from a stored value in a distributed ledger, or the like. In other embodiments, as will be described in further detail when completing the interaction, the interaction may include the interaction terminal providing the resources to the user 102 (e.g., in a digital wallet, in physical instrument, such as a card, paper document, or the like).

It should be understood that in some embodiments the interaction terminal 101 may be part of the interaction, such as it may be supported (e.g., owned or operated) by the entity that is part of the interaction (e.g., POS owned by the entity providing a product, ATM of an entity that manages a resource pool of an entity involved in the interaction, or the like). Alternatively, the interaction terminal may only facilitate the interaction for two unrelated entities, such as by serving as the authenticator of the entities for the interaction. For example, a user 102 may be using an interaction terminal 101A of a first entity to receive resources from a resource pool 104 of the user that is administered by a second entity.

In particular embodiments, the interaction is entered into by the user 102 in order to receive resources. In some embodiments the resources will be received from the users own resource pool, which may be linked to a blockchain and managed through a distributed register. In other embodiments, the resources will be provided, or have been pre-provided (e.g., pre-funded) by a second entity (e.g., second user or organization) for the user 102.

Block 320 of FIG. 3 illustrates that the user 102 may be authenticated through the use of the interaction terminal. For example, the user 102 may be authenticated using one or more identifiers, such as by providing a resource instrument (e.g., credit card, debit card, body scan—face, finger, or the like), inputting characters (e.g., pin code, string a numbers, letters, symbols, or the like), allowing communication with the user computer system 104 (e.g., GPS, NFC, wireless communication, or the like), or the like. The authentication may occur through the use of traditional authentication channels for the interaction terminals and/or the entities that traditionally authenticate users 104 using the interaction terminals 101.

In some embodiments the interaction terminal 101 may use a distributed register in order to authenticate the identity of the user 102. For example, the interaction terminal 101 may communicate with other interaction terminals 101n^{th} and/or the distributed ledger (e.g., a private blockchain, or the like) in order to authenticate one or more identifiers for the user 102. For example, one or more of the identifiers may be stored in the distributed leger of the blockchain that may be accessed by the interaction terminal 101 in order to authenticate the identity of the user 102 before interaction is allowed to proceed. As such, the interaction terminal may authenticate the resource pool number, pin number, name of the user, an expiration date, and/or another code provided by the user 102 based on what is stored and/or validated by one or more other nodes within the distributed leger. In some embodiments, the authentication of the user 102 may be performed and stored through the blockchain described with respect to FIG. 2.

FIG. 3. further illustrates in block 330 that an identification is made that the interaction requested by the user 102 is for a blockchain interaction. Since the interaction terminal 101 may be used for multiple purposes, the user 102 making the request may be required to make a selection that indicates that the interaction is going to use a distributed register for a blockchain. For example, the user 101 may request to make the interaction through the use of the distributed register, such as receiving resources that are digital resources that are stored on the distributed ledger, providing resources for storage on the distributed ledger, or the like interactions that are validated and stored on a blockchain. In other embodiments of the present disclosure, the user 101 may not specifically request that the interaction take place using resources through the use of a distributed register; however, the entity processing the interaction may complete the interaction using resources supported by the distributed ledger with or without the knowledge of the one or more entities in the interaction. It should be understood that the resources are transferred between resource pools of the entities in the interaction, in the same or different resource values. For example, in some embodiments the interaction may be converted into a store of value used by the distributed register in order to complete the interaction (e.g., currency value, to coin value, and potentially back to a different currency value). In other embodiments, the interaction may be validated and stored in a single resource value.

Block 340 in FIG. 3 illustrates that once the user 102 is authenticated, the interaction terminal 101 may generate the new block for the interaction. As described with respect to FIG. 2, the interaction terminal (e.g., ATM, or the like) generates the pending block for the interaction. In some embodiments the new pending block may be related to (e.g., point to) a chain of interactions that relate to the resource pool of the user 102 from which the resources are being received. In other embodiments, should the user 102 be receiving resources that are actually stored on the blockchain, the new pending block may be related to (e.g., point to) the block in which the resources are being stored on the blockchain. In still other embodiment, should the user 102 be receiving resources from a second entity the new pending block may be related to (e.g., point to) a resource pool of the second entity. In other embodiments, multiple new blocks may be crated to illustrate from where the resources are being received (e.g., a debit) and to where the resources are going (e.g., a credit).

As illustrated by block 350 in FIG. 3, unlike using traditional consensus from other nodes on the blockchain, the interaction may be validated through the use of the interaction terminal itself since the interaction terminal is a trusted node. As such, since the interaction terminal is a trusted node the new block (or blocks) for the interaction may be validated without having to solve a cryptographic puzzle, or the cryptographic puzzle difficulty is reduced because of the interaction terminal is a trusted node. In some embodiments, the pending block (or blocks) on the distributed register is validated as being created by the interaction terminal, there are no other blocks generated by the interaction terminal for the same interval, and the block is signed correctly by the interaction terminal. As previously discussed with respect to FIG. 2, the interaction may be completed through the use of a smart contract. Since the interaction terminal is a trusted node, the interaction can be validated more efficiently, in less time, an using less energy when compared to other traditional consensus validation.

FIG. 3 in block 360 further illustrates that system completes the interaction by transferring the resources. For example, depending on the interaction, the resource values are converted, distributed to the entities (e.g., users, organizations, or the like), a product is provided to the user 102, or the like. In some embodiments, the interaction terminal (e.g., ATM, cash recycler, or the like) may dispense the resource to the user through a resource instrument (e.g., dispense cash, print an instrument, associate resources with an instrument—assign a resource amount to a card, provide a negotiable instrument, or the like). In other embodiments, the interaction terminal may communicate wirelessly with the user computer system 104 in order to receive resources from, or distribute resources to, the user computer system 104 (e.g., a digital wallet of the user 102, or the like).

In particular embodiments of the invention, the resources are transferred wirelessly to the user computer system 104 (e.g., from the interaction terminal, or the like) and stored in a digital wallet on the user computer system 104. In other embodiments, the resources may be dispensed by the interaction terminal (e.g., the ATM, or the like) to the user 102 through resource instrument (e.g., paper, apply resources to a card, print and dispense paper or card, or the like). In some embodiments, the resources are provided (e.g., electronically or physically) to the user 104 at a value for a local resource (e.g., exchanged from a value being used by the second entity and/or the blockchain, to the local resource value). In this way, the user may be able to easily receive resources anywhere in the world for any resource value (e.g., any currency type).

It should be understood that the resources received by the user 102 (e.g., electronically or physically on a card) may be tied back to the distributed register. That is, when the resources are used by the user 102 in the future (e.g., used electronically from a wallet or by physically presenting a card on which the resources are stored), the future interaction of the user may be made through the distributed register from which the user 102 received the resources. In other embodiments of the invention, the resources received by the user 102 may be used in anyway with no ties back to the distributed register from which the user 102 received the resources.

U.S. patent application Ser. No. ______, entitled “CONSENSUS AUTHENTICATION UTILIZING NODES IN A DISTRIBUTED NETWORK OF NODES” filed on even date herewith, the entire disclosure of which is incorporated herein by reference.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined, or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for validating an interaction using a distributed network of nodes, the system comprising:
one or more memory devices with computer-readable program code stored thereon;
one or more communication devices; and
one or more processing devices operatively coupled to the one or more memory devices and the one or more communication devices, wherein the one or more processing devices are configured to execute the computer-readable program code to:
receive a request from a user to enter into an interaction using a node, wherein the node is an interaction terminal;
receive interaction information for the interaction;
authenticate the user making the request for the interaction;
identify that the interaction is for a blockchain interaction;
generate a new block for the blockchain interaction;
receive an indication that the new block is validated, wherein the new block is validated based on the interaction terminal used to create the new block; and
complete the interaction by electronically transferring resources to a user computer system of the user or dispensing physical resources to the user.

2. The system of claim 1, wherein authenticating the user making the request is performed using traditional authentication processes for interaction terminals.

3. The system of claim 1, wherein authenticating the user making the request is performed by a consensus of interaction terminals on the blockchain.

4. The system of claim 1, wherein the new block is generated by the interaction terminal using an interaction terminal identifier that is registered as a trusted authority.

5. The system of claim 4, wherein the new block is validated by one or more other nodes after confirming that the interaction terminal identifier is identified as the trusted authority.

6. The system of claim 1, wherein the new block is validated by one or more other nodes by:
determining that the new block was generated by the interaction terminal;
determining that there are no other blocks generated by the interaction terminal at a same interval; and
determining that the new block is signed correctly.

7. The system of claim 1, wherein the request to enter into the interaction is received from a user computer system of the user before the user accesses the interaction terminal.

8. The system of claim 7, wherein the new block is generated only after the user confirms the interaction through the interaction terminal.

9. The system of claim 7, wherein the new block is generated and the interaction is completed by the user through the user computer system without the user accessing the interaction terminal.

10. The system of claim 1, wherein the request to enter into the interaction is received from the user at the interaction terminal.

11. The system of claim 1, wherein the interaction terminal is an automated teller machine (ATM) or recycler.

12. The system of claim 11, wherein the computer-readable program code stored on the one or more memory devices, comprises:
semi-conductor computer-readable code;
interaction processing and encryption computer-readable code;
resource withdraw and deposit computer-readable code; and
blockchain computer-readable code for allowing the interaction terminal to communicate with the blockchain.

13. The system of claim 1, wherein the interaction terminal is a point of sale terminal.

14. The system of claim 1, wherein the interaction is completed by electronically transferring resources to the user computer system, and wherein a resource amount for the resources is stored in a digital wallet of the user on the user computer system.

15. The system of claim 1, wherein the interaction is completed by dispensing a resource instrument to the user, and wherein the resource instrument stores a resource amount for the resources through the resource instrument.

16. The system of claim 1, wherein the interaction is completed by exchanging a distributed register resource value for the distributed register into a local resource value for a location of the user.

17. The system of claim 1, wherein the interaction is completed by exchanging a second resource value from a second entity to a distributed register resource value for a distributed register, and exchanging the distributed register resource value into a local resource value for a location of the user.

18. A computer program product for validating an interaction using a distributed network of notes, the computer program product comprising at least one non-transitory computer readable medium having computer-readable program code portions embodied therein, the computer-readable program code portions comprising executable portions for:
receiving a request from a user to enter into an interaction using a node, wherein the node is an interaction terminal;
receiving interaction information for the interaction;
authenticating the user making the request for the interaction;
identifying that the interaction is for a blockchain interaction;
generating a new block for the blockchain interaction;
receiving an indication that the new block is validated, wherein the new block is validated based on the interaction terminal used to create the new block; and
completing the interaction by electronically transferring resources to a user computer system of the user or dispensing physical resources to the user.

19. The computer program product of claim 18, wherein the interaction is completed by electronically transferring resources to the user computer system, wherein a resource amount for the resources is stored in a digital wallet of the user on the user computer system, or by dispensing a resource instrument to the user, wherein the resource instrument stores the resource amount for the resources through the physical instrument.

20. A computer-implemented method for validating an interaction using a distributed network of nodes, the computer-implemented method comprising:
receiving, by one or more processors, a request from a user to enter into an interaction using a node, wherein the node is an interaction terminal;
receiving, by the one or more processors, interaction information for the interaction;
authenticating, by the one or more processors, the user making the request for the interaction;
identifying, by the one or more processors, that the interaction is for a blockchain interaction;
generating, by the one or more processors, a new block for the blockchain interaction;
receiving, by the one or more processors, an indication that the new block is validated, wherein the new block is validated based on the interaction terminal used to create the new block; and
completing, by the one or more processors, the interaction by electronically transferring resources to a user computer system of the user or dispensing physical resources to the user.
